(19) United States
(12) Patent Application Publication
(10) Pub. No.: US 2010/0265242 A1
(43) Pub. Date: Oct. 21, 2010

(54) POWER CIRCUIT AND DISPLAY DEVICE USING SAME

(76) Inventors: Naoki TAKADA, Yokohama (JP); Naruhiko Kasai, Yokohama (JP); Takuya Eriguchi, Yokosuka (JP); Yuki Okada, Tama (JP); Mitsuru Goto, Chiba (JP); Akihito Akai, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/760,582

(22) Filed: Apr. 15, 2010

(30) Foreign Application Priority Data
Apr. 16, 2009 (JP) 2009-099948

(51) Int. Cl. G06F 3/038; G05F 1/00

(52) U.S. Cl. 345/212; 323/282

(57) ABSTRACT

A power circuit includes a coil that charges an electric charge of an input voltage, a switch device that controls charging and discharging of the coil, a diode that rectifies the flow of the electric charge from the coil, a capacitor that stabilizes an output voltage when the switch device is turned on, and a driving circuit that controls ON and OFF states of the switch device. The power circuit alternately switches the ON and OFF states of the switch device to control charging and discharging of the coil and the capacitor, and generates and supplies an output voltage higher than the input voltage, and the driving circuit controls the off-period of the switch device according to the on-period of the switch device and the voltage ratio of the output voltage and the input voltage while changing the repetition period of the ON and OFF states of the switch device.

### CROSS-REFERENCE TO RELATED APPLICATION

The present application claims priority from Japanese application JP2009-099948 filed on Apr. 16, 2009, the content of which is hereby incorporated by reference into this application.

### BACKGROUND OF THE INVENTION

1. Field of the Invention

The present invention relates to a power circuit and a display device using the same. More particularly, the present invention relates to a power circuit and a display device, which can improve power efficiency with respect to a load with large difference between times of high and low load.

2. Description of the Related Art

As a power circuit in a display device driving circuit for driving a liquid crystal panel, a switching regulator capable of producing high efficiency power with high accuracy while reducing power loss has been used. The switching regulator performs a step-up operation by charging an electric charge of an input voltage in a coil and discharging the electric charge charged in the coil. In relation to a charge period and a discharge period of the electric charge of the coil, the ratio (duty ratio) of ON/OFF time of a switching device using a MOS-FET and the like is controlled, and an output voltage is determined by the duty ratio.

As the switching regulator, a power circuit is disclosed in JP-A-2006-54969. The power circuit disclosed in JP-A-2006-54969 compares a preset target voltage to be supplied to a load with an output voltage to control the duty ratio according to the voltage difference between the target voltage and the output voltage. As the voltage difference increases, the power circuit increases the ON time. In detail, when the output voltage is higher than the reference voltage, the on-period of the duty ratio is increased. As the voltage difference between the output voltage and the target voltage increases, the ON time is increased.

### SUMMARY OF THE INVENTION

As disclosed in JP-A-2006-54969, controlling the duty ratio of ON/OFF time will be referred to as PWM (Pulse Width Modulation) control. According to the PWM control disclosed in JP-A-2006-54969, a PWM cycle is constant. In such a case, a Low period (in which current flows from a supply voltage to an output voltage due to turning off of a switch device and counter electromotive force of a coil) of a PWM signal is determined according to a High period of the PWM signal.

Therefore, when the PWM cycle is constant and the High period of the PWM signal is short, the Low period of the PWM signal is set up with redundancy. Particularly, if the Low period of the PWM signal is long, the voltage drop amount of an output voltage is increased, resulting in an increase of the High period of the PWM signal. However, if the High period of the PWM signal is increased, power efficiency may be reduced.

In view of the above, it is an object of the invention to provide a power circuit and a display device, which can step up an output voltage by using a short High period of a PWM signal through the optimization of PWM timing control.

The invention adopts the following configuration in order to solve the above-described problems. That is, according to an aspect of the invention, a power circuit includes: a coil that charges an electric charge of an input voltage, a switch device that controls charging and discharging of the coil, a diode that rectifies the flow of the electric charge from the coil, a capacitor that stabilizes an output voltage when the switch device is turned on, and a driving circuit that controls ON and OFF states of the switch device, wherein the power circuit alternately switches the ON and OFF states of the switch device to control charging and discharging of the coil and the capacitor, and generates and outputs an output voltage higher than the input voltage, and the driving circuit controls the off -period of the switch device according to the on-period of the switch device and the voltage ratio of the output voltage and the input voltage while changing the repetition period of the ON and OFF states of the switch device.

According to another aspect of the invention, a power circuit includes: a coil that charges an electric charge of an input voltage, a switch device that controls charging and discharging of the coil, a diode that rectifies the flow of the electric charge from the coil, a capacitor that stabilizes an output voltage when the switch device is turned on, and a driving circuit that controls ON and OFF states of the switch device, wherein the power circuit alternately switches the ON and OFF states of the switch device to control charging and discharging of the coil and the capacitor, and generates and outputs an output voltage higher than the input voltage, and the driving circuit controls the off-period of the switch device according to the on-period of the switch device and the voltage ratio of the output voltage and the input voltage while controlling the on-period and the off-period of the switch device such that the repetition period of the ON and OFF states of the switch device coincides with any one of at least two repetition periods different from each other.

According to further another aspect of the invention, a power circuit includes: a coil that charges an electric charge of an input voltage, a switch device that controls charging and discharging of the coil, a diode that rectifies the flow of the electric charge from the coil, a capacitor that stabilizes an output voltage when the switch device is turned on, a driving circuit that controls ON and OFF states of the switch device, and a detection circuit that detects a discharge current from the coil, wherein the power circuit alternately switches the ON and OFF states of the switch device to control charging and discharging of the coil and the capacitor, and generates and outputs an output voltage higher than the input voltage, and the driving circuit controls the off-period of the switch device based on a period in which the discharge current detected by the detection circuit becomes zero.

According to further another aspect of the invention, a display device includes: a display driving circuit including any one of the power circuits according to the above-described three aspects of the invention, and a display panel that displays an image according to display data from the display driving circuit.

According to the invention, it is possible to step up the output voltage by using a short High period of a PWM signal through the optimization of PWM timing control.

### BRIEF DESCRIPTION OF THE DRAWING

FIG. 1 is a diagram schematically illustrating the configuration of a display device according to a first embodiment of the invention;

FIG. 2A is a diagram illustrating a step-up operation of a switching regulator step-up circuit (power circuit) in a display device according to a first embodiment of the invention;

FIG. 2B is a diagram illustrating a step-up operation of a switching regulator step-up circuit (power circuit) in a display device according to a first embodiment of the invention;

FIG. 2C is a diagram illustrating a step-up operation of a switching regulator step-up circuit (power circuit) in a display device according to a first embodiment of the invention;

FIG. 3A is a diagram illustrating a step-up operation of a conventional switching regulator step-up circuit;

FIG. 3B is a diagram illustrating a step-up operation of a conventional switching regulator step-up circuit;

FIG. 3C is a diagram illustrating a step-up operation of a conventional switching regulator step-up circuit;

FIG. 4A is a diagram illustrating a PWM control method in a display device according to a first embodiment of the invention;

FIG. 4B is a diagram illustrating a PWM control method in a display device according to a first embodiment of the invention;

FIG. 5 is block diagram illustrating a PWM generation circuit in a display device according to a first embodiment of the invention;

FIG. 6A is a timing chart illustrating a circuit operation of a PWM generation circuit in a display device according to a first embodiment in the invention;

FIG. 6B is a timing chart illustrating a circuit operation of a PWM generation circuit in a display device according to a first embodiment in the invention;

FIG. 7 is a diagram illustrating a PWM control method in a display device according to a second embodiment of the invention;

FIG. 8A is a timing chart illustrating a circuit operation of a PWM generation circuit in a display device according to a second embodiment in the invention;

FIG. 8B is a timing chart illustrating a circuit operation of a PWM generation circuit in a display device according to a second embodiment in the invention;

FIG. 9 is a diagram schematically illustrating the configuration of a display device according to a third embodiment of the invention;

FIG. 10 is a diagram illustrating a step-up operation of a switching regulator step-up circuit in a display device according to a third embodiment of the invention;

FIG. 11 is block diagram illustrating a PWM generation circuit in a display device according to a third embodiment of the invention;

FIG. 12A is a timing chart illustrating a circuit operation of a PWM generation circuit in a display device according to a third embodiment in the invention; and

FIG. 12B is a timing chart illustrating a circuit operation of a PWM generation circuit in a display device according to a third embodiment in the invention.

### DETAILED DESCRIPTION OF THE INVENTION

Hereinafter, preferred embodiments of the invention will be described with reference to the accompanying drawings. In the following description, the same reference numerals are used to designate the same elements in order to avoid redundancy.

### First Embodiment

(Configuration of Liquid Crystal Display Device)

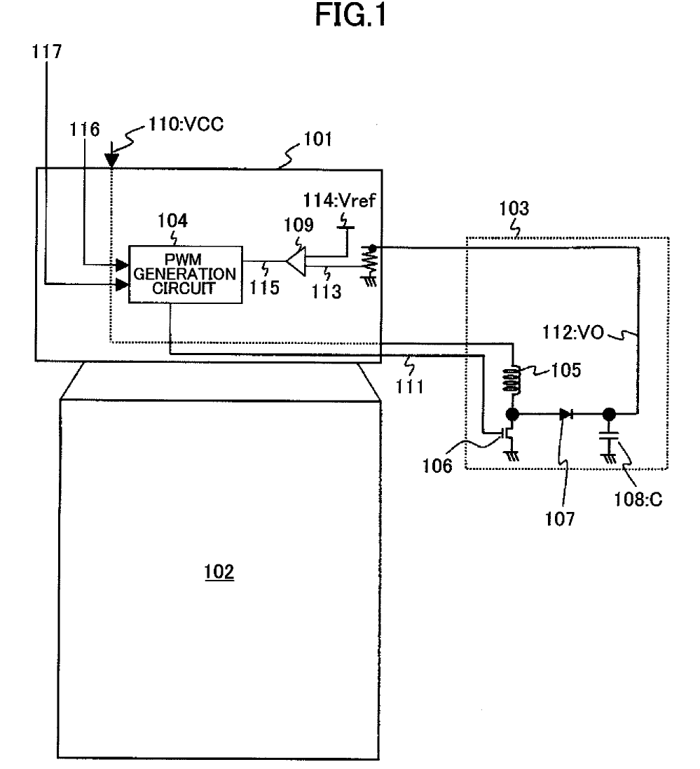

FIG. 1 is a diagram schematically illustrating the configuration of a display device according to a first embodiment of the invention. In the following description, a liquid crystal display device is used as the display device. However, the invention is not limited thereto.

As clearly seen from FIG. 1, the display device according to the first embodiment of the invention includes a liquid crystal driver 101, a liquid crystal panel 102 and a switching regulator step-up circuit 103. A well-known backlight apparatus and the like (not shown) is provided in the liquid crystal panel 102. Further, an interface circuit with a CPU, a register circuit including a setting register and a grayscale voltage generation circuit for generating a grayscale voltage (not shown) and the like, are provided in the liquid crystal driver 101.

In detail, the liquid crystal driver 101 includes a PWM generation circuit (driving circuit) 104 and a comparator 109, which constitute a power circuit according to the first embodiment. After an UPDOWM selection signal 115 (an output signal from the comparator 109), a horizontal period synchronizing signal (horizontal synchronizing signal) 116 and a vertical period synchronizing signal (vertical synchronizing signal) 117 are input to the PWM generation circuit 104, a PWM signal 111 is output from the PWM generation circuit 104 in synchronization with the horizontal synchronizing signal 116 and the vertical synchronizing signal 117. Further, after a reference voltage (Vref) 114 and a divided step-up voltage 113 are input to the comparator 109, a result obtained by comparing the reference voltage (Vref) 114 with the divided step-up voltage 113 is output from the comparator 109 as the UPDOWM selection signal 115. According to the embodiment, after the horizontal synchronizing signal 116 and the vertical synchronizing signal 117 are input to the PWM generation circuit 104, the PWM generation circuit 104 operates in synchronization with the horizontal synchronizing signal 116 and the vertical synchronizing signal 117. However, the PWM generation circuit 104 may not synchronize with the horizontal synchronizing signal 116 and the vertical synchronizing signal 117. Further, the PWM generation circuit 104, which is an essential element of the embodiment, will be described later. In addition, the divided step-up voltage 113 is obtained by dividing the output voltage (step-up voltage VO (112)), which is supplied from the switching regulator step-up circuit 103, through a well-known resistor.

The switching regulator step-up circuit 103 includes a coil 105, a MOS switch (switch device) 106, a diode 107 and a capacitor (C) 108. The coil 105 has one end connected to a supply voltage (VCC) 110 and the other end connected to one end of the MOS switch 106 and the anode side of the diode 107. The MOS switch 106 has a drain connected to one end of the coil and the anode side of the diode, a source connected to the ground, and a gate to which the PWM signal 111 is input. The diode 107 has the anode side connected to one end of the coil 105 and the drain side of the MOS switch 106, and the cathode side through which the step-up voltage (VO) 112 is input to the liquid crystal driver 101. The capacitor (C) 108 has one end connected to the cathode side of the diode 107 and the other end connected to the ground. According to the embodiment, an NMOS is used as the MOS switch 106. However, a PMOS may also be used as the MOS switch 106. Further, the coil 105, the MOS switch 106 and the diode 107, which are elements of the switching regulator step-up circuit 103, are external components. However, the MOS switch 106 and the diode 107 may also be provided in the liquid crystal driver.

(Conventional Power Circuit)

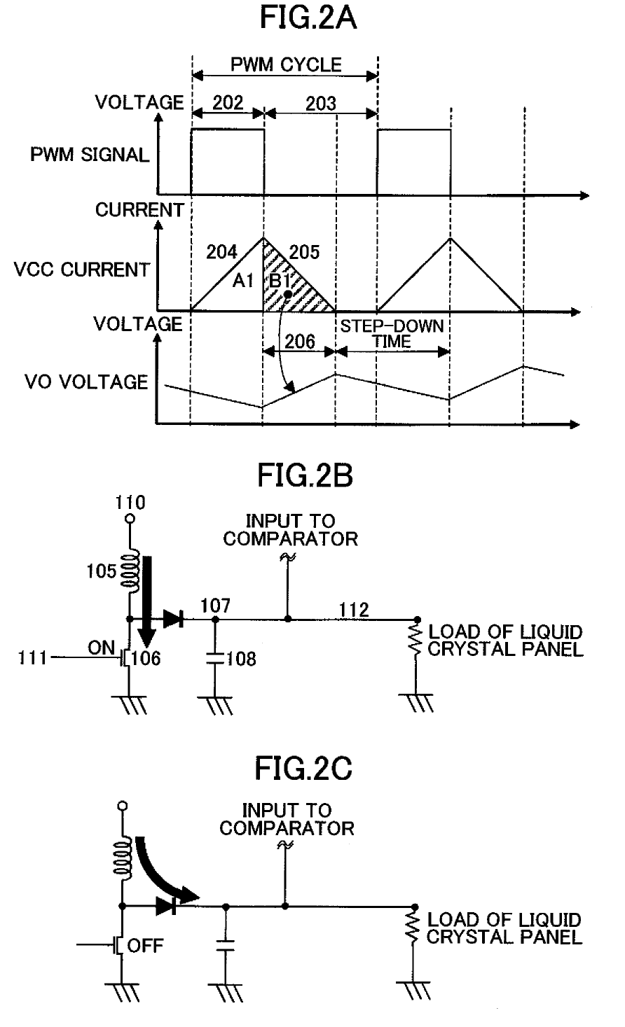

FIGS. 2A to 2C are diagrams illustrating the step-up operation of a switching regulator step-up circuit in a conventional power circuit. Particularly, FIG. 2A is a timing chart illustrating a PWM signal, a VCC current and a VO voltage, FIG. 2B is a circuit diagram illustrating the operation of the switching regulator step-up circuit in a High period 202 of the PWM signal, and FIG. 2C is a circuit diagram illustrating the operation of the switching regulator step-up circuit in a Low period 203 of the PWM signal.

Hereinafter, the step-up operation of the switching regulator step-up circuit will be described based on FIGS. 2A to 2C. Since an NMOS is used as the MOS switch 106, the MOS switch 106 is turned on in the High period 202 of the PWM signal 111, so that the supply voltage (VCC) 110 is applied to one end of the coil 105. At this time, an electric charge is charged in the coil. Herein, a charge current 204 to the coil 105 is expressed by Equation 1 below. In Equation 1, L denotes an inductance value (unit: Henry) of the coil and T denotes a period in which the MOS switch is turned on. Thus, an I (VCC) current value when the High period of the PWM signal 111 is ended is equal to VCC/L×Ton.

$$I ( VCC ) = \frac{VCC}{L} \times T \qquad ( 1 )$$

Next, in the Low period 203 of the PWM signal, the MOS switch 106 is turned off, so that electromotive force is generated in the coil 105. At this time, the electric charge charged in the coil 105 is discharged, and the step-up voltage (VO) 112 is increased by a discharge current 205. Herein, the discharge current 205 from the coil is expressed by Equation 2 below. In Equation 2, L denotes an inductance value (unit: Henry) of the coil and VCC/L×Ton of a second term denotes a charge current charged in the High period of the PWM signal 111.

$$I ( VCC ) = \frac{( VCC - VO )}{L} \times T + \frac{VCC}{L} \times {T}_{on} \qquad ( 2 )$$

The time Toff at which the discharge current 205 from the coil becomes zero is equal to the time when I (VCC) in Equation 2 becomes zero. Thus, as expressed by Equation 3 below, the Toff can be represented by the High period (Ton) of the PWM signal 111, the step-up voltage (VO) and the supply voltage (VCC). For example, when the step-up voltage is twice as high as the supply voltage, the Toff is equal to the Ton.

$${T}_{off} = \frac{VCC}{( VO - VCC )} \times {T}_{on} = \frac{1}{( VO / {VCC}^{- 1} )} \times {T}_{on} \qquad ( 3 )$$

Herein, the time Toff is equal to a step-up time 206. That is, the step-up voltage (VO) 112 is stepped down (reduced) before a subsequent High period 202 of the PWM signal starts after the time Toff lapses from the Low period 203 of the PWM signal. In the conventional PWM control method, such a phenomenon causes a reduction in efficiency.

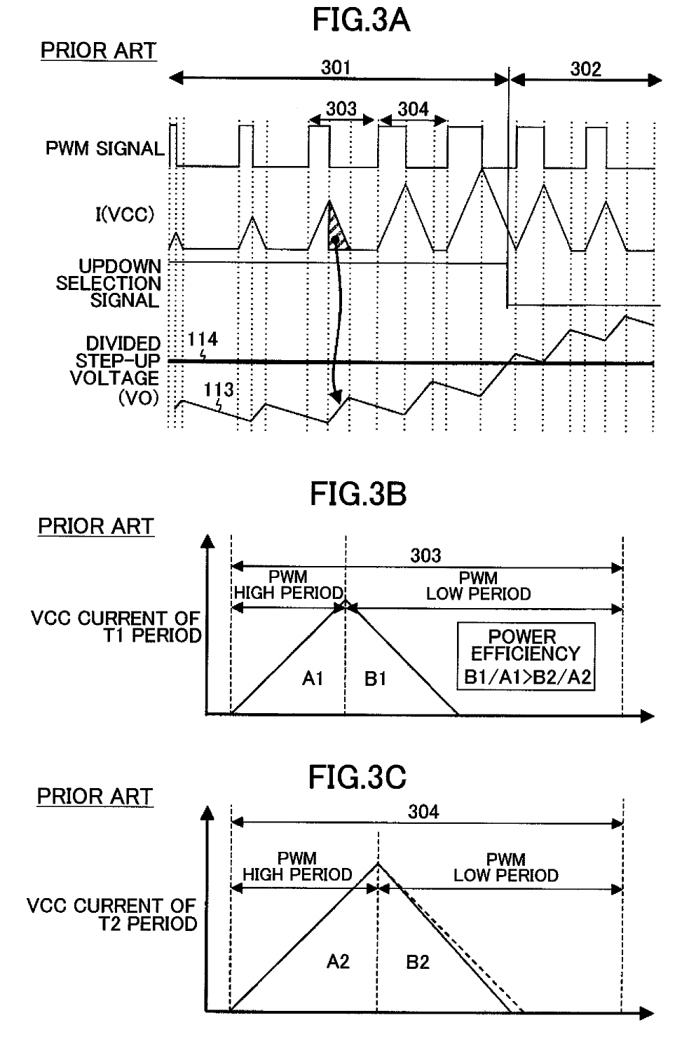

FIGS. 3A to 3C are diagrams illustrating a PWM control method in a conventional power circuit. Particularly, FIG. 3A is a diagram illustrating the conventional PWM control method, and FIGS. 3B and 3C are diagrams illustrating the difference of power efficiency due to the difference of the charge time. According to the conventional method, the PWM cycle is constant.

In FIG. 3A, the UPDOWM selection signal 115 is obtained by comparing the divided step-up voltage (VO) 113 with the reference voltage (Vref)) 114. When the divided step-up voltage (VO) 113 is lower than the reference voltage (Vref) 114, the UPDOWM selection signal 115 is in a high state. However, when the divided step-up voltage (VO) 113 is higher than the reference voltage (Vref) 114, the UPDOWM selection signal 115 is in a low state.

Herein, the PWM operation is individually performed in the period 301 in which the High width of the PWM signal is increased, and the period 302 in which the High width of the PWM signal is reduced according to the UPDOWM selection signal. When the UPDOWM selection signal 115 is in the high state, the PWM operation is performed in the period 301 in which the High width of the PWM signal is increased. However, when the UPDOWM selection signal 115 is in the low state, the PWM operation is performed in the period 302 in which the High width of the PWM signal is reduced. In detail, in the period 301 in which the High width of the PWM signal is increased, the High width of the PWM signal is gradually widened in a constant PWM cycle. Meanwhile, in the period 302 in which the High width of the PWM signal is reduced, the High width of the PWM signal is gradually shortened in the constant PWM cycle. As described in FIGS. 2A to 2C, the time required for the step-up time 206 is equal to the Toff. The time Toff can be calculated by the time Ton, the step-up voltage VO and the supply voltage VCC as expressed by Equation 3. In the T1 period 303 in which the time Ton is short, the time Toff is also shortened. Thus, in the T1 period, a decrement of the step-up voltage is large. As a result, since the step-up voltage VO reaches the target voltage, it is necessary to perform the PWM control of increasing the High width of the PWM signal.

Hereinafter, the difference of power efficiency between the T1 period 303 and the T2 period 304 when the PWM cycle is constant will be described. The power efficiency peff is the ratio of output power with respect to input power, which is expressed by Equation 4 below.

$${P}_{eff} = \frac{VO \times I ( VO )}{VCC \times I ( VCC )} \qquad ( 4 )$$

In Equation 4, VO denotes a-step-up voltage, I (VO) denotes a step-up current, VCC denotes a supply voltage and I (VCC) denotes a supply current.

Herein, I (VCC) denotes (A1+B1) of FIG. 3B or (A2+B2) of FIG. 3C, and I (VO) denotes B1 of FIG. 3B or B2 of FIG. 3C. Thus, the power efficiency Peff is determined by area efficiency of A1+B1 or area efficiency of A2+B2 as expressed by Equation 5 below.

$${P}_{eff} = \frac{VO \times B 1}{VCC \times ( A 1 + B 1 )} = \frac{VO}{VCC \times ( 1 + A 1 / B 1 )} \qquad ( 5 )$$

For example, when the step-up voltage VO is twice as high as the supply voltage VCC, the ratio of A1:B1 when the power efficiency is 90% becomes 1:0.82 by Equation 5. Further, as clearly seen from Equation 5, as the ratio of A1:B1 is small, the power efficiency is improved. If the power efficiency in the T1 period 303 is compared with the power efficiency in the T2 period 304, the fact that the power efficiency in the T2 period 304 is lowered can be understood through a simulation and the like. It is expected that this is caused by the following reasons. Since the Low period of the PWM signal after the Toff is long in the Ti period, the moving amount of an electric charge, which flows from the voltage stabilization capacitor (C) 108 provided in the cathode side of the diode 107 of FIG. 1 to the load of the liquid crystal panel 102, is increased in the step-down period (period until the High period of the PWM signal is ended after the Toff) of the T1 period 303. The discharge current of the subsequent T2 period 304 is supplied to the load of the liquid crystal panel 102 and the capacitor (C) 108. As described above, when the PWM cycle is constant, the decrement of the step-up voltage when the High period of the PWM signal is short is increased, so that power efficiency becomes worse when a current is supplied in a subsequent PWM cycle.

### Power Circuit of First Embodiment

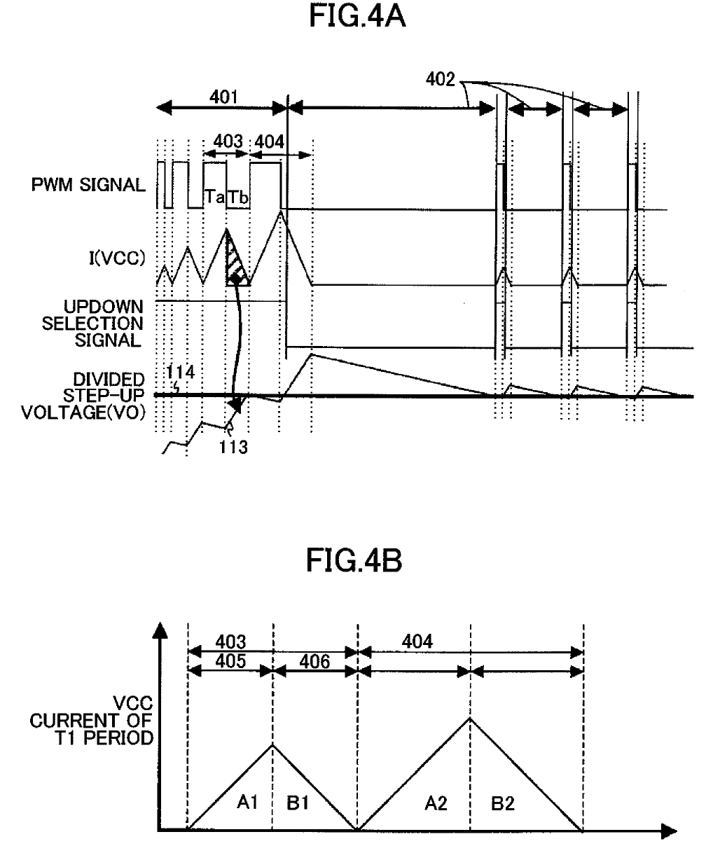

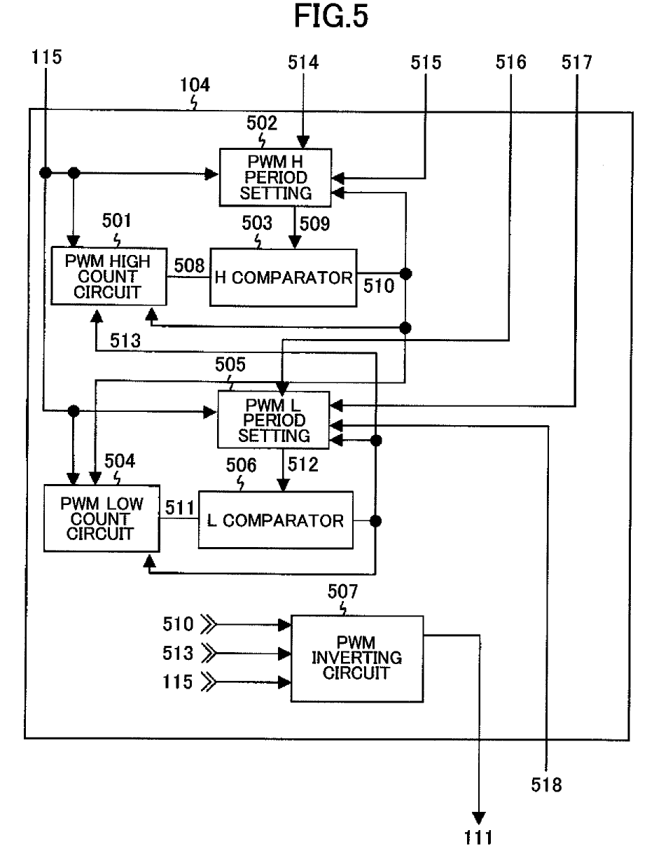

FIGS. 4A and 4B are diagrams illustrating a PWM control method in a power circuit of the first embodiment. Particularly, FIG. 4A is a diagram illustrating the PWM control method of the first embodiment and FIG. 4B is a diagram illustrating power efficiency due to the difference of the charge time. As clearly seen from FIG. 4A, according to the first embodiment, the PWM operation is individually performed in the period 401 in which the High width of the PWM signal is increased and the period 402 in which the operation of the PWM signal is stopped (output stop). These two periods 401 and 402 are determined by the UPDOWN selection signal 115. According to the first embodiment, when the UPDOWM selection signal 115 is in the high state, the PWM operation is performed in the period 401 in which the High width of the PWM signal is increased. However, when the UPDOWM selection signal 115 is in the low state, the PWM operation is performed in the period 402 in which the operation of the PWM signal is stopped. Further, the UPDOWM selection signal 115 is obtained by comparing the divided step-up voltage (VO) 113 with the reference voltage (Vref) 114. When the divided step-up voltage (VO) 113 is lower than the reference voltage (Vref) 114, the UPDOWM selection signal 115 is in the high state. However, when the divided step-up voltage (VO) 113 is higher than the reference voltage (Vref) 114, the UPDOWM selection signal 115 is in the low state.

In the period 401 in which the High width of the PWM signal is increased, the High width of the PWM signal is gradually widened similarly to the related art. However, the PWM cycle is not constant but variable. Herein, each PWM cycle is determined by the sum of the Ton and the Toff. For example, in the T1 period 403, when the time of the High period 405 of the PWM signal is defined as Ta, the time Tb of the Low period 406 of the PWM signal is found by Equation 3 and is equal to VCC/(VO−VCC)×Ta. Further, in the T2 period 404, the High period of the PWM signal is defined as Ta′ (Ta′>Ta) and the Low period Tb′ of the PWM signal is equal to VCC/(VO−VCC)×Ta′. With the above control, the decrement of the step-up voltage after the Toff can be minimized, so that the power efficiency can be improved.

(Configuration of PWM Generation Circuit)

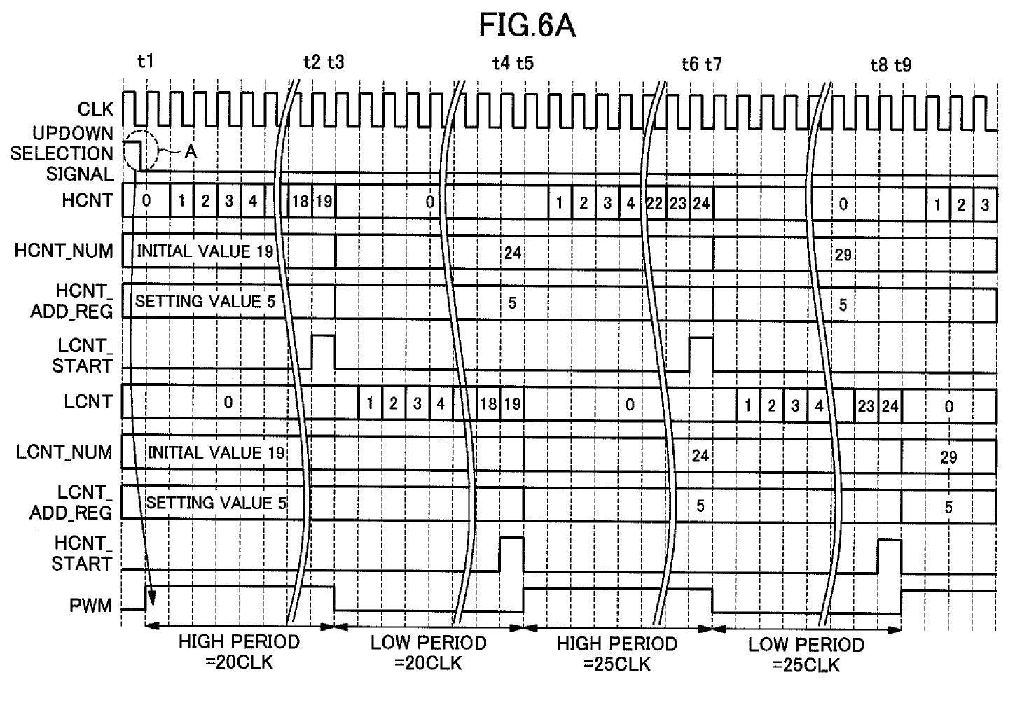

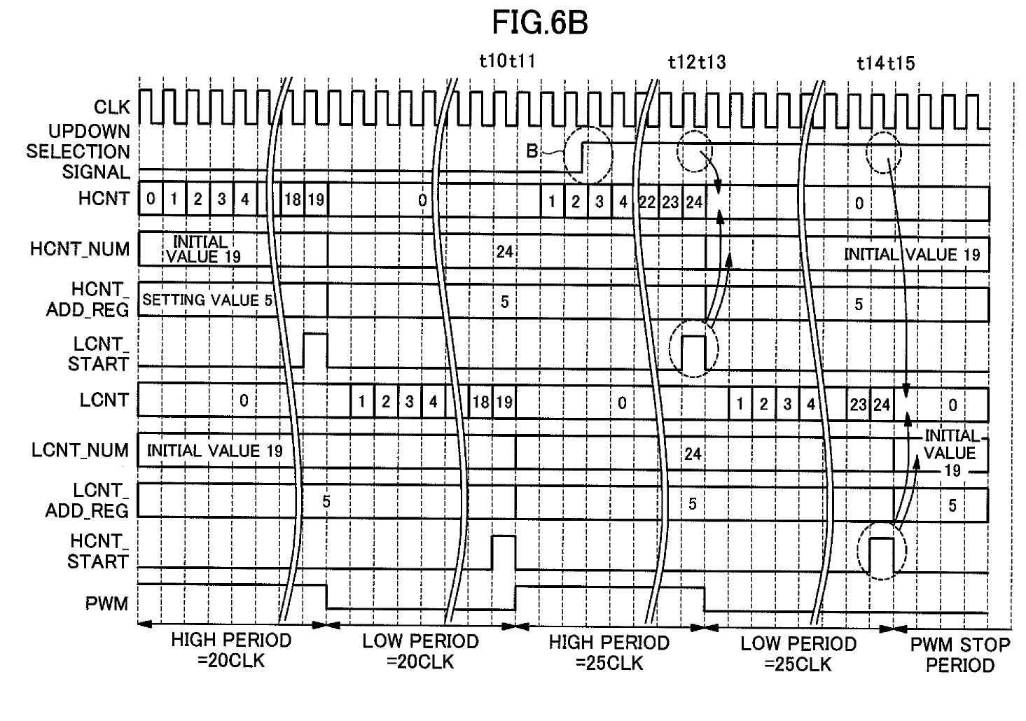

FIG. 5 is block diagram illustrating the PWM generation circuit according to the first embodiment of the invention and FIGS. 6A and 6B are timing charts illustrating a circuit operation of the PWM generation circuit according to the first embodiment. Hereinafter, the PWM generation circuit according to the first embodiment will be described based on FIG. 5 and FIGS. 6A and 6B. In detail, FIG. 6A is a diagram illustrating the PWM circuit operation when the UPDOWM selection signal is in the low state and FIG. 6B is a diagram illustrating the PWM circuit operation when the UPDOWM selection signal is in the high state.

According to the PWM generation circuit of the first embodiment shown in FIG. 5, HCNT_NUM_REG and LCNT_NUM_REG are individually input to the PWM generation circuit. However, for example, the HCNT_NUM_REG may be input to a PWMH period setting block 502 and a PWML period setting block 505. Further, register setting values at the time of the circuit operation shown in FIGS. 6A and 6B include HCNT_NUM_REG (=19), HCNT_ADD_REG (=5), LCNT_NUM_REG (=19) and LCNT_ADD_REG (=5). However, the register setting values are not limited thereto. In addition, in the circuit operation shown in FIGS. 6A and 6B, VO is equal to 2×VCC, that is, BOOST_MAG, which is equal to VCC/(VO−VCC) expressed by Equation 3, is 1.

As clearly seen from FIG. 5, the PWM generation circuit 104 according to the first embodiment includes a PWM HIGH count block 501, a PWMH period setting block 502, an H comparator block 503, a PWM LOW count block 504, a PWML period setting block 505, an L comparator block 506 and a PWM inverting block 507.

Input signals are the above-described UPDOWN selection signal 115, the register value (HCNT_NUM_REG) 514 for setting a HIGH period initial value of the PWM signal, the register value (HCNT_ADD_REG) 515 for setting the increment/decrement of the High period of the PWM signal when the PWM cycle is updated, the register value (LCNT_NUM_REG) 516 for setting a LOW period initial value of the PWM signal, the register value (LCNT_ADD_REG) 517 for setting the increment/decrement of the Low period of the PWM signal when the PWM cycle is updated, and the value (BOOST_MAG) 518 of VCC/(VO−VCC) which is the relationship of the step-up voltage VO and the supply voltage VCC in Equation 3. The output signal is the PWM signal 111.

Next, the PWM circuit operation will be described. The UPDOWN selection signal 115 is input to the PWM HIGH count block 501, the PWMH period setting block 502, the PWM LOW count block 504, the PWML period setting block 505 and the PWM inverting block 507. The inside of the PWM HIGH count block 501, the PWMH period setting block 502, the PWM LOW count block 504 and the PWML period setting block 505 is reset when the UPDOWM selection signal 115 is in the “High” state. The PWM inverting block 507 detects the falling edge of the UPDOWM selection signal 115 and allows the PWM signal 111 to be in a high state, so that an electric charge starts in the coil.

Herein, when the UPDOWM selection signal 115 is in the “Low” state, an output count value (HCNT) 508 of the PWM HIGH count block 501 is counted up from zero. The HCNT value 508 is compared with a HIGH period setting value (HCNT_NUM) 509 of the PWM signal, which is output from the PWMH period setting block 502, by the H comparator block 503. Herein, when the HCNT is equal to the HCNT_NUM, a LOW period start signal (LCNT_START) 510 of the PWM signal, which is output from the H comparator block 503, is in a High state.

The LCNT_START 510 is input to the PWM HIGH count block 501, the PWMH period setting block 502, the PWM LOW count block 504 and the PWM inverting block 507. The PWM HIGH count block 501 stops the count by employing the LCNT_START 510 in the High state as a trigger. Herein, the initial value is set to zero. The PWMH period setting block 502 performs an update to a value, which is obtained by adding the HCNT_ADD_REG 515 to the signal HCNT_NUM 509, by employing the LCNT_START 510 in the High state as a trigger. The PWM LOW count block 504 counts up an output count value (LCNT) 511 from zero by employing the LCNT_START 510 in the High state as a trigger. The PWM inverting block 507 inverts the PWM signal to a Low state by employing the LCNT_START 510 in the High state as a trigger.

Then, the output count value (LCNT) 511 of the PWM LOW count block 504 having received the signal LCNT_START 510 is counted up from zero. At this time, in the PWM generation circuit 104 according to the first embodiment, the PWML period setting block 505 generates a LOW period setting value (LCNT_NUM) 512 of the PWM signal based on a value obtained by multiplying step-up magnification (i.e., VCC/(VO−VCC)) input as the signal BOOST_MAG 518 by the LOW period initial value of the PWM signal, which is input as the signals LCNT_NUM_REG 516 and LCNT_ADD_REG 517, and the increment/decrement of the Low period of the PWM signal when the PWM cycle is updated. The value LCNT 511 is compared with the LOW period setting value (LCNT_NUM) 512 of the PWM signal, which is output from the PWML period setting block 505, by the L comparator block 506. When the LCNT is equal to the LCNT_NUM, a HIGH period start signal (HCNT_START) 513 of the PWM signal, which is output from the L comparator block 506, is in a High state. The HCNT_START 513 is input to the PWM LOW count block 504, the PWML period setting block 505, the PWM HIGH count block 501 and the PWM inverting block 507.

The PWM LOW count block 504 stops the count by employing the HCNT_START 513 in the High state as a trigger. Herein, the initial value is set to zero. The PWML period setting block 505 performs an update to a value, which is obtained by adding the LCNT_ADD_REG 517 to the LCNT_NUM 512, by employing the HCNT_START 513 in the

High state as a trigger. The PWM HIGH count block 501 counts up the output count value (HCNT) 508 from zero by employing the HCNT_START 513 in the High state as a trigger. The PWM inverting block 507 inverts the PWM signal to a High state by employing the HCNT START 513 in the High state as a trigger. The above-described operation is sequentially repeated, so that the operation of the PWM generation circuit is performed.

That is, in the power circuit according to the first embodiment, as indicated by a dotted circle A of FIG. 6A, when the UPDOWN selection signal is changed to the Low state from the High state, the PWM signal 111 output from the PWM inverting block 507 is inverted to the High state from the Low state at the falling edge of a subsequent clock signal CLK, so that the MOS switch is turned on (time t1). Further, the PWM HIGH count block 501 counts the clock CLK from the time t1, the LOW period start signal (LCNT_START) 510 of the PWM signal is output from the H comparator block 503 for one clock period at the timing (time t2) at which the count value HCNT 508 becomes 19 (initial value) which is the HIGH period setting value (HCNT_NUM) 509 of the PWM signal. At the time t3 at which the LOW period start signal (LCNT_START) 510 of the PWM signal starts to fall, the PWM signal 111 with the High period of 20 clocks is inverted to a Low state from a High state, so that the MOS switch is turned off. Further, at the time t3, after the PWM LOW count block 504 starts to count the clock CLK and the count value HCNT 508 of the PWM HIGH count block 501 is reset to zero, a value 24, which is obtained by adding 5 input as the HCNT_ADD_REG signal 515 to 19 (the previous count value), is output from the PWMH period setting block 502 as the HCNT_NUM 509.

At the timing (time t4) at which the count value LCNT 511 of the PWM LOW count block 504 becomes 19 which is the LOW period setting value (LCNT_NUM) 512 of the PWM signal, the HIGH period start signal (HCNT_START) 513 of the PWM signal is output from the L comparator block 506 for one clock period. At the time t5 at which the HIGH period start signal (HCNT_START) 513 of the PWM signal starts to fall, the PWM signal 111 with the Low period of 20 clocks is inverted to the High state from the Low state, so that the MOS switch is turned on. Further, at the time t5, the PWM HIGH count block 501 starts to count the clock CLK and the count value LCNT 511 of the PWM LOW count block 504 is reset to zero. In addition, at the time t5, the PWML period setting block 505 adds the increment/decrement 5 from the LCNT_ADD_REG 517 to the initial value 19 from the LCNT_NUM_REG 516, and outputs a value 24, which is obtained by multiplying the additional value 24 by a step-up magnification 1 (i.e., VCC/(VO−VCC)) input as the signal BOOST_MAG 518, as the LCNT_NUM 512.

At the timing (time t6) at which the count value HCNT 508 of the PWM HIGH count block 501 becomes 24 which is the HIGH period setting value (HCNT_NUM) 509 of the PWM signal, the LOW period start signal (LCNT_START) 510 is output for one clock period. At the time t7 at which the LOW period start signal (LCNT_START) 510 starts to fall, the PWM signal 111 with the High period of 25 clocks is inverted to the Low state from the High state, so that the MOS switch is turned off. Further, at the time t7, after the PWM LOW count block 504 starts to count the clock CLK and the PWM HIGH count block 501 is reset to zero, a value 29, which is obtained by adding 5 to 24, is output from the PWMH period setting block 502 as the HCNT_NUM 509.

At the timing (time t8) at which the count value LCNT 511 of the PWM LOW count block 504 becomes 24 which is the LOW period setting value (LCNT_NUM) 512 of the PWM signal, the HIGH period start signal (HCNT_START) 513 is output for one clock period. At the time t9 at which the HIGH period start signal (HCNT_START) 513 starts to fall, the PWM signal 111 with the Low period of 25 clocks is inverted to the High state from the Low state, so that the MOS switch is turned on. Further, at the time t9, the PWM HIGH count block 501 starts to count the clock CLK and the PWM LOW count block 504 is reset to zero. In addition, at the time t9, a value 24 is obtained by adding the increment/decrement 5 from the LCNT_ADD_REG 517 to the initial value 19 from the LCNT_NUM REG 516. Then, an additional value 29 is obtained by further adding 5 to the value 24. Then, a value obtained by multiplying the additional value 29 by the step-up magnification 1 is output as the LCNT_NUM 512.

When the UPDOWN selection signal is changed to the Low state from the High state, the above-described operation is repeated, so that the supply voltage VCC is stepped up to the step-up voltage VO.

Next, the case in which the UPDOWN selection signal is changed to the High state from the Low state, that is, an operation after the supply voltage VCC is stepped up to the step-up voltage VO will be described based on FIG. 6B. As indicated by a dotted circle B of FIG. 613, when the UPDOWN selection signal is changed to the High state from the Low state, the operation performed during the change thereof, that is, counting (an operation when the UPDOWN selection signal is in the Low state) of the clock CLK by the PWM HIGH count block 501 from the time t11 is continued. At the timing (time t12) at which the count value HCNT 508 becomes 24 which is the HIGH period setting value (HCNT_NUM) 509, the LOW period start signal (LCNT_START) 510 of the PWM signal is output from the H comparator block 503 for one clock period. At the time t13 at which the LOW period start signal (LCNT_START) 510 of the PWM signal starts to fall, the PWM signal 111 with the High period of 25 clocks is inverted to the Low state from the High state, so that the MOS switch is turned off. Further, at the time t13, after the PWM LOW count block 504 starts to count the clock CLK and the count value HCNT 508 of the PWM HIGH count block 501 is reset to zero, 19 (i.e., the initial value), which is obtained by subtracting 5 input as the signal HCNT_ADD_REG 515 from 24 (the previous count value), is output from the PWMH period setting block 502 as the HCNT_NUM 509.

At the timing (time t14) at which the count value LCNT 511 of the PWM LOW count block 504 becomes 24 which is the LOW period setting value (LCNT_NUM) 512 of the PWM signal, the HIGH period start signal (HCNT_START) 513 of the PWM signal is output from the L comparator block 506 for one clock period. At the time t15 at which the HIGH period start signal (HCNT_START) 513 of the PWM signal starts to fall, after the PWM signal 111 with the Low period of 25 clocks is output, the Low period is maintained, that is, the output of the PWM signal is stopped. That is, at the time t15, the counting of the clock CLK by the PWM HIGH count block 501 is stopped, and the count value LCNT 511 of the PWM LOW count block 504 is reset to zero. In addition, at the time t15, the PWML period setting block 505 outputs a value 19, which is obtained by subtracting 5 from 24 (the just immediately count value), as the LCNT_NUM 512.

As described above, according to the power circuit of the first embodiment, when the UPDOWN selection signal is changed to the High state from the Low state, after the PWM operation performed during the change thereof is ended, the PWM operation is stopped and the output is allowed to be in the low state, so that the MOS switch is continuously turned off.

In the above description, the horizontal period synchronizing signal 116 and the vertical period synchronizing signal 117, which are input to the PWM generation circuit 104 shown in FIG. 1, are not described. However, the PWM generation circuit 104 operates in synchronization with the horizontal period synchronizing signal 116 and the vertical period synchronizing signal 117. For example, after the horizontal period synchronizing signal 116 and the vertical period synchronizing signal 117 are input to the PWM generation circuit 104, when line switching and frame switching are performed, the entire circuit may operate after being initialized. Further, at the timing at which the line switching and the frame switching are performed, since the charge/discharge current to the panel is expected to be large, even when the UPDOWN selection signal 115 is in the Low state, the PWM operation circuit may operate.

As described above, the power circuit according to the first embodiment of the invention includes the coil 105 that charges an electric charge of an input voltage, the MOS switch (switch device) 106 that controls charging and discharging of the coil 105, the diode 107 that rectifies the flow of an electric charge from the coil 105, the capacitor 108 that stabilizes an output voltage when the MOS switch 106 is turned on, and the PWM generation circuit 104 that generates the PWM signal 111, which is used for generating a clock signal serving as a reference of the charge/discharge operation of the coil 105 and the capacitor 108, according to the UPDOWN selection signal 115 obtained by comparing the voltage 113, which is obtained by dividing the step-up voltage (VO) 112, with the reference voltage (Vref) 114 by the comparator circuit 109. The PWM control is performed in an operation period and a stop period. In the operation period, the PWM generation circuit 104 does not fix the PWM cycle during the PWM operation, and determines the Low period of the PWM signal according to the time (Ton) of the High period of the PWM signal and the ratio (step-up voltage/supply voltage) of the step-up voltage 112 with respect to the supply voltage VCC as expressed by Equation 3. Consequently, a decrement of the step-up voltage 112 can be suppressed, resulting in the improvement of power efficiency.

When an output voltage higher than an input voltage is generated by controlling the charge/discharge operation of the coil 105 and the capacitor 108 by switching ON and OFF states of the MOS switch 106 alternately, the PWM generation circuit 104 serving as a driving circuit that controls the ON and OFF states of the MOS switch 106 variably controls the repetition period of the ON and OFF states of the MOS switch 106 according to the on-period of the MOS switch 106 and the voltage ratio of the output voltage with respect to the input voltage. Consequently, the output voltage can be stepped up by using a short High period of the PWM signal, and a decrement of the output voltage caused by variation of power consumption amount of the liquid crystal panel 102 (voltage supply destination), that is, a load can be suppressed, resulting in the improvement of power efficiency. In addition, in the display device according to the first embodiment, since the PWM generation circuit 104 controls the off-period of the MOS switch 106 according to the on-period of the MOS switch 106 and the voltage ratio of the output voltage with respect to the input voltage, even when the power consumption amount of the liquid crystal panel 102 is small, the output voltage can be prevented from being increased and the step-up operation is stopped, so that it is possible to obtain a significant effect that power efficiency is improved.

According to the first embodiment as described above, the PWM operation is divided in the operation period and the stop period. In the stop period, the PWM signal is stopped and in the operation period, the PWM signal operates. In addition, the PWM cycle is not fixed and the Low period of the PWM signal is determined according to the High period thereof.

### Second Embodiment

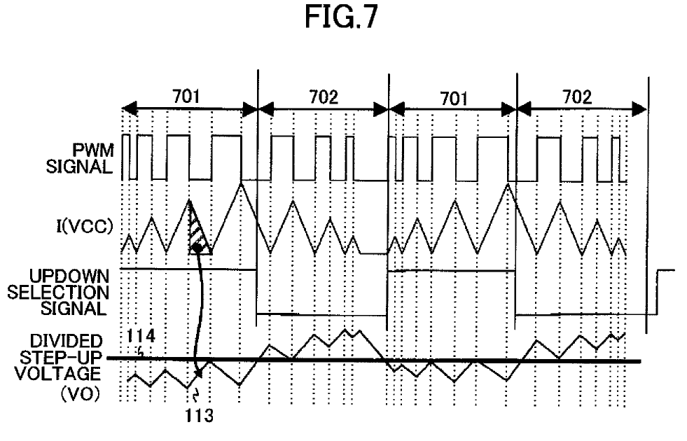

FIG. 7 is a diagram illustrating PWM control of a power circuit in a display device according to a second embodiment of the invention. Since the display device according to the second embodiment is substantially identical to the display device according to the first embodiment, except for a PWM control method, the PWM control will be described in detail based on FIGS. 1 and 7.

A PWM operation of the PWM generation circuit according to the second embodiment is individually performed in a period 701 in which the High width of the PWM signal is increased, and the period 702 in which the High width of the PWM signal is reduced. These two periods are determined by the UPDOWN selection signal 115. When the UPDOWM selection signal 115 is in a high state, the PWM operation is performed in the period 701 in which the High width of the PWM signal is increased. However, when the UPDOWM selection signal 115 is in the Low state, the PWM operation is performed in the period 702 in which the High width of the PWM signal is reduced. Further, the UPDOWM selection signal 115 is obtained by comparing the divided step-up voltage (VO) 113 with the reference voltage (Vref)) 114. When the divided step-up voltage (VO) 113 is lower than the reference voltage (Vref)) 114, the UPDOWM selection signal 115 is in the high state. However, when the divided step-up voltage (VO) 113 is higher than the reference voltage (Vref) 114, the UPDOWM selection signal 115 is in the Low state. In the period 701 in which the High width of the PWM signal is increased, the High width of the PWM signal is gradually widened and the PWM cycle is not constant but variable even in the second embodiment. Herein, each PWM cycle is determined by the sum of the Ton and the Toff. The relationship between the Ton and the Toff is determined similarly to the first embodiment. Thus, when the time of the High period of the PWM signal is defined as Ta, the time Tb of the Low period of the PWM signal is found by Equation 3 and is equal to VCC/(VO−VCC)×Ta. With the above control, the decrement of the step-up voltage after the time Toff can be minimized, so that the power efficiency can be improved.

Further, in the period 701 in which the High width of the PWM signal is increased, the High width of the PWM signal is gradually widened and the PWM cycle is not constant but variable. Herein, each PWM cycle is determined by the sum of the Ton and the Toff. The relationship between the Ton and the Toff is determined similarly to the first embodiment. Thus, when the time of the High period of the PWM signal is defined as Ta, the time Tb of the Low period of the PWM signal is found by Equation 3 and is equal to VCC/(VO−VCC)×Ta. With the above control, the decrement of the step-up voltage after the time Toff can be minimized, so that the power efficiency can be improved.

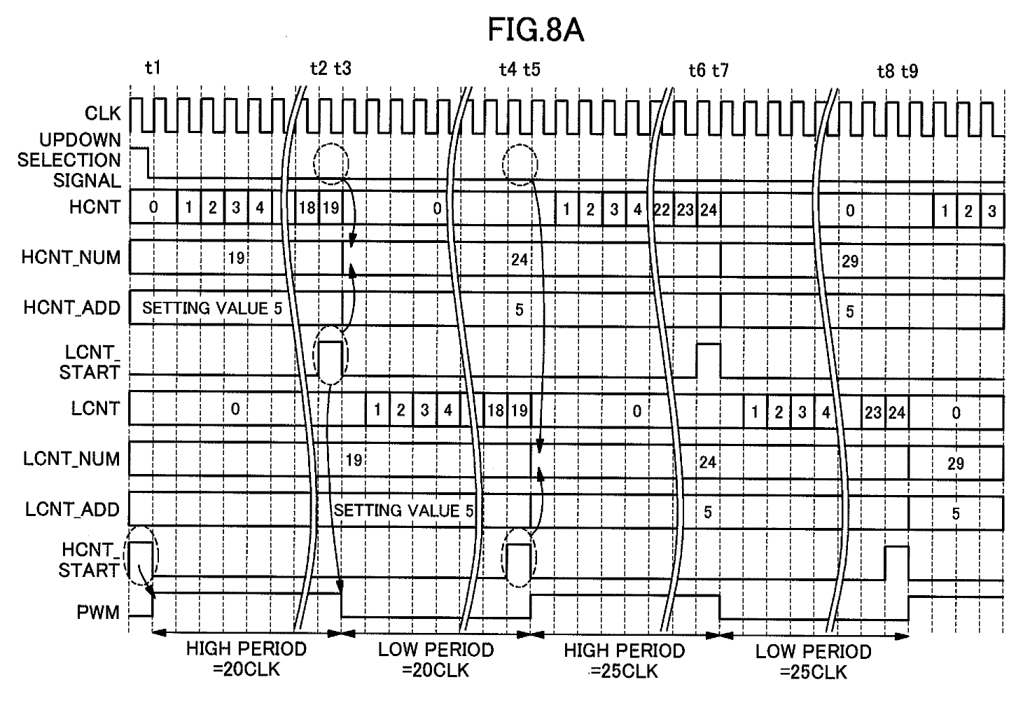

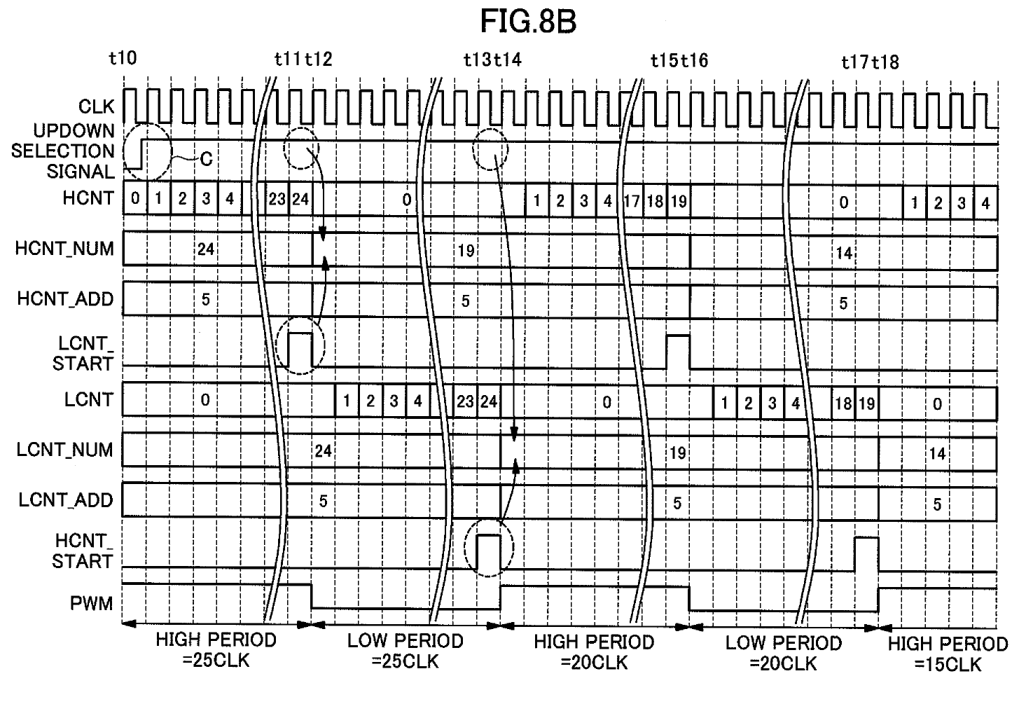

FIGS. 8A and 8B are timing charts illustrating a circuit operation of the PWM generation circuit in the display device according to the second embodiment of the invention. Hereinafter, the operation of the PWM generation circuit 104 according to the second embodiment will be described based on FIG. 5 and FIGS. 8A and 8B. As described above, since the display device according to the second embodiment is substantially identical to the display device according to the first embodiment, except for a PWM control method, the operation of the PWM generation circuit 104 related to the PWM control will be described in detail. Further, register setting values at the time of the circuit operation shown in FIGS. 8A and 8B include HCNT_NUM REG (=19), HCNT ADD REG (=5), LCNT_NUM_REG (=19) and LCNT_ADD_REG (=5). However, the register setting values are not limited thereto. In addition, in the circuit operation shown in FIGS. 8A and 8B, VO is equal to 2×VCC, that is, BOOST_MAG is 1.

The input UPDOWN selection signal 115 is connected to the PWM HIGH count block 501, the PWMH period setting block 502, the PWM LOW count block 504, the PWML period setting block 505 and the PWM inverting block 507. When the UPDOWN selection signal 115 is in the “High” state, in the PWMH period setting block 502 and the PWML period setting block 505, the register setting values (HCNT_ADD_REG) 515 and (LCNT_ADD_REG) 517 each are added to the register setting values (HCNT_NUM_REG) 514 and (LCNT_NUM_REG) 516 which are the counter initial values of the High width and Low width of the PWM signal, so that the counter values (HCNT_NUM and LCNT_NUM) 509 and 512 of the High width and Low width of the PWM signal are updated. Further, when the UPDOWN selection signal 115 is in the “Low” state, in the PWMH period setting block 502 and the PWML period setting block 505, the register setting values (HCNT_ADD_REG) 515 and (LCNT_ADD_REG) 517 each are subtracted from the register setting values (HCNT_NUM_REG) 514 and (LCNT_NUM_REG) 516 which are the counter initial values of the High width and Low width of the PWM signal, so that the counter values (HCNT_NUM and LCNT_NUM) 509 and 512 of the High width and Low width of the PWM signal are updated.

Herein, an operation when the UPDOWN selection signal 115 is in the “Low” state is substantially identical to the operation of the first embodiment described with reference to FIG. 6A, as clearly seen from FIG. 8A. That is, the PWM signal has the Low period of 20 clocks from the time t3 to the time t5 after the High period of 20 clocks from the time t1 to the time t3. In the period (t5 to t7) subsequent to the Low period, the PWM output is performed in the High period of 25 clocks. In the period (t7 to t9), the PWM output is performed in the Low period of 25 clocks. The above PWM operation is repeated until the UPDOWN selection signal 115 is in the “High” state, so that the supply voltage VCC is increased to the step-up voltage VO in the power circuit according to the second embodiment.

Next, the case in which the UPDOWN selection signal 115 is in the “High” state will be described. The output count value (HCNT) 508 of the PWM HIGH count block 501 is counted up from zero. The HCNT value is compared with the HIGH period setting value (HCNT_NUM) 509 of the PWM signal, which is output from the PWMH period setting block 502, by the H comparator block 503. When the HCNT is equal to the HCNT_NUM, the LOW period start signal (LCNT_START) 510 of the PWM signal, which is output from the H comparator block 503, is in a High state. The LCNT_START 510 is input to the PWM HIGH count block 501, the PWMH period setting block 502, the PWM LOW count block 504 and the PWM inverting block 507. The PWM HIGH count block 501 stops the count by employing the LCNT_START 510 in the High state as a trigger. Herein, the initial value is set to zero. The PWMH period setting block 502 performs an update to a value, which is obtained by subtracting the HCNT_ADD_REG from the signal HCNT_NUM 509, by employing the LCNT_START 510 in the High state as a trigger. The PWM LOW count block 504 counts up the output count value (LCNT) 511 from zero by employing the LCNT_START 510 in the High state as a trigger. The PWM inverting block 507 inverts the PWM signal to a Low state by employing the LCNT_START 510 in the High state as a trigger.

Then, the output count value (LCNT) 511 of the PWM LOW count block 504 having received the signal LCNT_START 510 is counted up from zero. The value LCNT is compared with the LOW period setting value (LCNT_NUM) 512 of the PWM signal, which is output from the PWML period setting block 505, by the L comparator block 506. When the LCNT is equal to the LCNT_NUM, the HIGH period start signal (HCNT_START) 513 of the PWM signal, which is output from the L comparator block 506, is in a High state. The HCNT_START 513 is input to the PWM LOW count block 504, the PWML period setting block 505, the PWM HIGH count block 501 and the PWM inverting block 507. The PWM LOW count block 504 stops the count by employing the HCNT_START 513 in the High state as a trigger. Herein, the initial value is set to zero. The PWML period setting block 505 performs an update to a value, which is obtained by subtracting the LCNT_ADD_REG 517 from the LCNT_NUM 512, by employing the HCNT_START 513 in the High state as a trigger. The PWM HIGH count block 501 counts up the output count value (HCNT) 508 from zero by employing the HCNT_START 513 in the High state as a trigger. The PWM inverting block 507 inverts the PWM signal to a High state by employing the HCNT_START 513 in the High state as a trigger. The above-described operation is sequentially repeated, so that the operation of the PWM generation circuit is performed.

That is, as indicated by a dotted circle C of FIG. 8B, when the UPDOWN selection signal is changed to the High state from the Low state, the operation performed during the change thereof, that is, an operation when the UPDOWN selection signal is in the Low state is performed. In other words, the HCNT_NUM (=24) and the LCNT_NUM (=24) at the time t10 are counted in the PWM HIGH count block 501 and the PWM LOW count block 504, respectively. As a result of the counting, the PWM signal has a High period of 25 clocks between the time t10 to the time t12 and a Low period of 25 clocks between the time t12 to the time t14. At this time, at the timing (time t11) at which the count value HCNT 508 of the PWM HIGH count block 501 becomes 24 that is the HIGH period setting value (HCNT_NUM) 509 of the PWM signal, the LOW period start signal (LCNT_START) 510 is output for one clock period. At the time t12 at which the LOW period start signal (LCNT_START) 510 starts to fall, the PWM LOW count block 504 starts to count the clock CLK. Further, at the time t12, after the PWM HIGH count block 501 is reset to zero, a value 19, which is obtained by subtracting 5 (the register setting value HCNT_ADD_REG) from 24 (the immediately previous setting value), is output from the PWMH period setting block 502 as the HCNT_NUM 509.

At the timing (time t13) at which the count value LCNT 511 of the PWM LOW count block 504 becomes 24 which is the LOW period setting value (LCNT_NUM) 512 of the PWM signal, the HIGH period start signal (HCNT_START) 513 of the PWM signal is output from the L comparator block 506 for one clock period. At the time t14 at which the HIGH period start signal (HCNT_START) 513 of the PWM signal starts to fall, the PWM signal 111 with the Low period of 25 clocks is changed to the High state from the Low state, so that the MOS switch is turned on Further, at the time t14, the PWM HIGH count block 501 starts to count the clock CLK and the count value LCNT 511 of the PWM LOW count block 504 is reset to zero. In addition, at the time t14, the PWML period setting block 505 outputs a value 19, which is obtained by subtracting 5 set by the LCNT_ADD_REG 517 from 24 (the just immediately LOW period setting value (LCNT_NUM) 512) and then multiplying the subtraction value 19 by the step-up magnification 1 (i.e., VCC/(VO−VCC)) input as the signal BOOST_MAG 518, as the LCNT_NUM 512.

At the timing (time t15) at which the count value HCNT 508 of the PWM HIGH count block 501 becomes 19 which is the HIGH period setting value (HCNT_NUM) 509 of the PWM signal, the LOW period start signal (LCNT_START) 510 is output for one clock period. At the time t16 at which the LOW period start signal (LCNT_START) 510 starts to fall, the PWM LOW count block 504 starts to count the clock CLK. Further, at the time t16, after the PWM HIGH count block 501 is reset to zero, a value 14, which is obtained by subtracting 5 (the register setting value HCNT_ADD_REG) from 19 (initial value) serving as the just immediately setting value, is output from the PWMH period setting block 502 as the HCNT_NUM 509.

At the timing (time t17) at which the count value LCNT 511 of the PWM LOW count block 504 becomes 19 which is the LOW period setting value (LCNT_NUM) 512 of the PWM signal, the HIGH period start signal (HCNT_START) 513 of the PWM signal is output from the L comparator block 506 for one clock period. At the time t18 at which the HIGH period start signal (HCNT_START) 513 of the PWM signal starts to fall, the PWM signal 111 with the Low period of 20 clocks is changed to the High state from the Low state, so that the MOS switch is turned on. Further, at the time t18, the PWM HIGH count block 501 starts to count the clock CLK and the count value LCNT 511 of the PWM LOW count block 504 is reset to zero. In addition, at the time t18, the PWML period setting block 505 outputs a value 14, which is obtained by subtracting 5 set by the LCNT_ADD_REG 517 from 19 (the just immediately LOW period setting value (LCNT_NUM) 512) and then multiplying the subtraction value 14 by the step-up magnification 1 (i.e., VCC/(VO−VCC)) input as the signal BOOST_MAG 518, as the LCNT_NUM 512.

As described above, according to the second embodiment, even when the HCNT_NUM_REG and the LCNT_NUM_REG are smaller than the initial value 19, the HIGH period setting value (HCNT_NUM) and the LOW period setting value (LCNT_NUM) of the PWML signal are set based on the increment/decrement set by the HCNT ADD_REG and the LCNT_ADD_REG.

In the above example, the horizontal period synchronizing signal 116 and the vertical period synchronizing signal 117, which are input to the PWM generation circuit 104 of FIG. 1 according to the first embodiment, are not described. However, the PWM generation circuit 104 can operate in synchronization with the horizontal period synchronizing signal 116 and the vertical period synchronizing signal 117. For example, after the horizontal period synchronizing signal 116 and the vertical period synchronizing signal 117 are input to the PWM generation circuit 104, when line switching and frame switching are performed, the entire circuit may operate after being initialized. Further, at the timing at which the line switching and the frame switching are performed, since charge/discharge current of the panel is expected to be large, even when the UPDOWN selection signal 115 is in the Low state, the UPDOWN selection signal 115 may be changed in the period in which the High width of the PWM signal is increased.

As described above, the power circuit according to the second embodiment includes the coil 105 that charges an electric charge of an input voltage, the MOS switch 106 that controls charging and discharging of the coil 105, the diode 107 that rectifies the flow of the electric charge from the coil 105, the capacitor 108 that stabilizes an output voltage when the MOS switch 106 is turned on, and the PWM generation circuit 104 that generates the PWM signal 111, which is used for generating a clock signal serving as a reference of the charge/discharge operation of the coil 105 and the capacitor 108, according to the UPDOWN selection signal 115 obtained by comparing the voltage 113, which is obtained by dividing the step-up voltage (VO) 112, with the reference voltage (Vref) 114 by the comparator circuit 109. The PWM operation is performed in a period in which the High period is increased and in a period in which the High period is reduced. The PWM generation circuit of the PWM signal does not fix the PWM cycle during the PWM operation, and determines the Low period of the PWM signal according to the time (Ton) of the High period of the PWM signal and the ratio (step-up voltage/supply voltage) of the step-up voltage with respect to the supply voltage as expressed by Equation 3. In this way, when a high load is applied to the panel, image degradation can be prevented and a decrement of the step-up voltage can be suppressed, resulting in the improvement of power efficiency.

That is, in the power circuit of the display device according to the second embodiment, when an output voltage higher than an input voltage is generated by controlling the charge/discharge operation of the coil 105 and the capacitor 108 by switching ON and OFF states of the MOS switch 106 alternately, the PWM generation circuit 104 serving as a driving circuit that controls the ON and OFF states of the MOS switch 106 variably controls the repetition period of the ON and OFF states of the MOS switch 106 based on Equation 3 according to the on-period of the MOS switch 106 and the voltage ratio of the output voltage with respect to the input voltage. Consequently, the output voltage can be stepped up by using a short High period of the PWM signal, and the voltage drop amount of the output voltage caused by variation of power consumption amount of the liquid crystal panel 102 (voltage supply destination), that is, a load can be suppressed, resulting in the improvement of power efficiency.

As described above, since the power circuit according to the second embodiment does not have a function of stopping a step-up operation, it is adapted for a power circuit with respect to a load causing relatively high power consumption.

### Third Embodiment

(Configuration of Liquid Crystal Display Device)

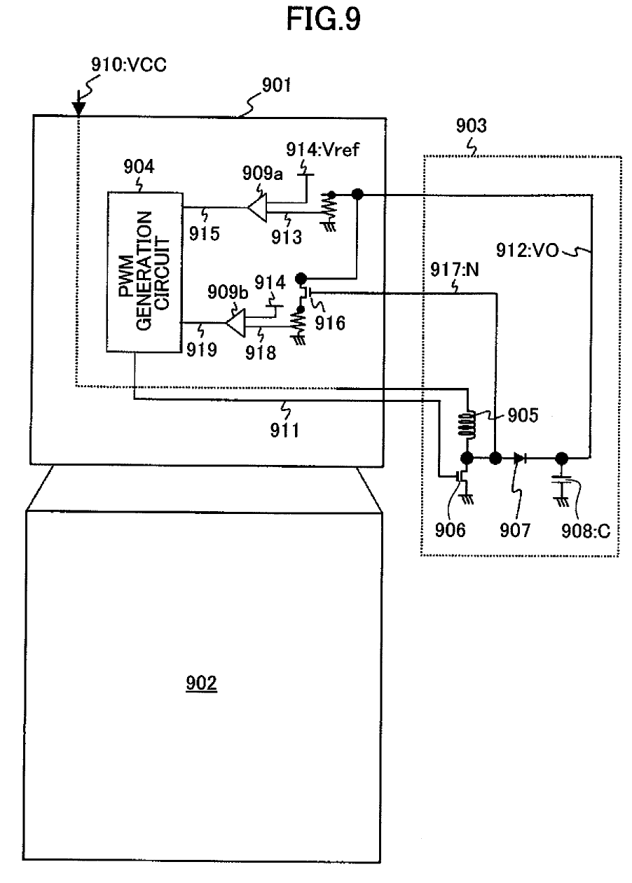

FIG. 9 is a diagram schematically illustrating the configuration of a display device according to a third embodiment of the invention. The display device of the third embodiment is substantially identical to the display device of first embodiment, except that the display device of the third embodiment has a configuration of determining a Toff period by detecting the time, at which a discharge current of the coil ends, from an internal node of a switching regulator step-up circuit. Therefore, the configuration of detecting the time, at which the discharge current of the coil ends, and control thereof will be described in detail.

As clearly seen from FIG. 9, the display device according to the third embodiment includes a liquid crystal driver 901, a liquid crystal panel 902 and a switching regulator step-up circuit 903. A well-known backlight apparatus and the like (not shown) is provided in the liquid crystal panel 902. Further, an interface circuit with a CPU, a register circuit including a setting register and a grayscale voltage generation circuit for a generating a grayscale voltage (not shown) and the like, are provided in the liquid crystal driver 901.

In detail, the liquid crystal driver 901 includes a PWM generation circuit 904 and two comparators 909a and 909b. The PWM generation circuit 904 receives an UPDOWM selection signal 915 (an output signal from the comparator 909a) and a current OFF determination signal 919 (an output signal from the comparator 909b) to output a PWM signal 911. A reference voltage (Vref) 914 and a divided step-up voltage 913 are input to the comparator 909a, so that the UPDOWM selection signal 915 is output therefrom. The reference voltage (Vref) 914 and a second divided step-up voltage 918 are input to the comparator 909b, so that the current OFF determination signal 919 is output therefrom.

The switching regulator step-up circuit 903 includes a coil 905, a MOS switch 906, a diode 907 and a capacitor (C) 908. The coil 905 has one end connected to a supply voltage (VCC) 910 and the other end connected to one end of the MOS switch 906 and an anode side of the diode 907. The MOS switch 906 includes a drain connected to one end of the coil 905 and the anode side of the diode, a gate to which the PWM signal 911 is input, and a source connected to the ground. According to the embodiment, an NMOS is used as the MOS switch 906. However, a PMOS may be used as the MOS switch 906.

The anode side of the diode 907 is connected to one end of the coil 905, the drain side of the MOS switch 906 and an internal node (N) 917. The internal node (N) 917 is input to the liquid crystal driver 901 and connected to a gate of a MOS switch 916. Herein, the MOS switch 916 has one end connected to a step-up voltage (VO) and the other end connected to a resistor for resistance division. Further, the cathode side of the diode 907 is output to the liquid crystal driver 901 as the step-up voltage (VO) 912. The capacitor (C) 908 has one end connected to the cathode side of the diode 907 and the other end connected to the ground. Herein, the coil 905, the MOS switch 906 and the diode 907, which are elements of the switching regulator step-up circuit 903, are external components. However, the MOS switch 906 and the diode 907 may also be provided in the liquid crystal driver.

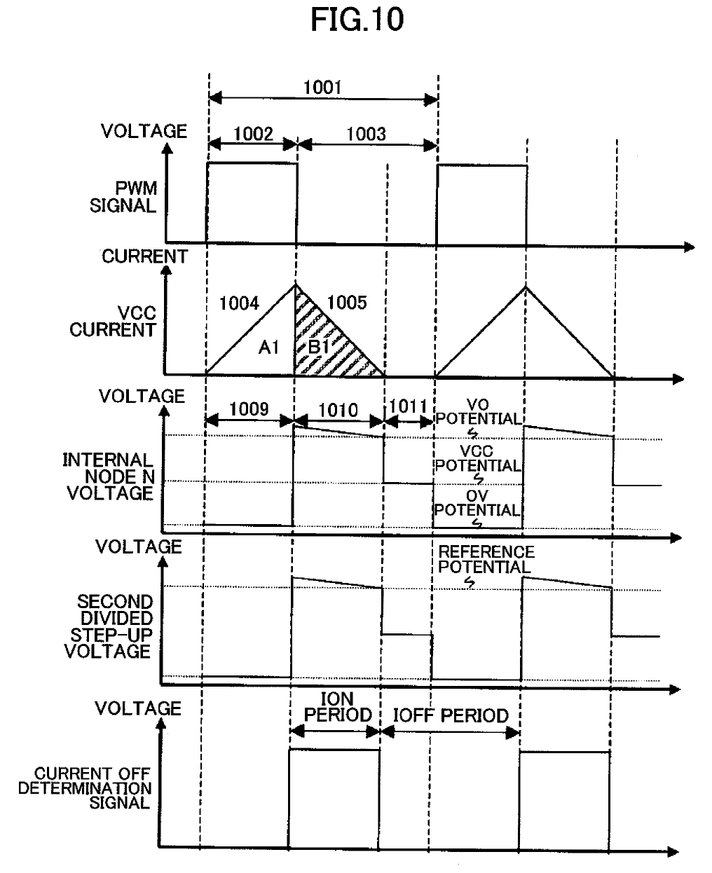

FIG. 10 is a diagram illustrating the step-up operation of the switching regulator step-up circuit in the display device according to the third embodiment of the invention. Hereinafter, an internal node N signal operation and current OFF determination will be described based on FIG. 10. In the High period 1002 of one cycle 1001 of a PWM signal, a charge current 1004 to the coil flows as a supply current I (VCC). In the Low period 1003 of the PWM signal, a discharge current from the coil flows as the supply current I (VCC). Herein, the Low period 1003 of the PWM signal is divided into the period before the supply current I (VCC) becomes zero and the period after the supply current I (VCC) becomes zero. Next, the potential state of the internal node (N) 917 in an operation of the supply current I (VCC) will be described.

In the T1 period 1009 serving as the High period 1002 of the PWM signal, the MOS switch 906 is turned on, so that the internal node (N) 917 is in a ground level. In the T2 period 1010 serving as the Low period of the PWM signal in which the supply current (VCC) is not zero, the MOS switch 906 is turned off and the discharge current flows, so that the voltage of the internal node (N) 917 is equal to or more than the step-up voltage. In the T3 period 1011 serving as the Low period of the PWM signal in which the supply current (VCC) becomes zero, the coil serves as a conductive line, so that the voltage of the internal node (N) 917 is equal to the supply voltage (VCC). As described above, the internal node (N) 917 is connected to the gate of the MOS switch 916. In the T2 period 1010 in which the gate voltage of the MOS switch 916 is equal to or more than the step-up voltage, the MOS switch 916 has low resistance, so that the second divided step-up voltage 918 is equal to or more than the reference voltage (Vref) 914. Further, in the T1 period 1009 and the T3 period 1011 in which the gate voltage of the MOS switch 916 is equal to or less than the step-up voltage, the MOS switch 916 has high resistance, so that the second divided step-up voltage 918 is equal to or more than the reference voltage (Vref) 914. As a result, the current OFF determination signal 919 is in a High state in the T2 period 1010, and a Low state in other periods.

(Configuration of PWM Generation Circuit)

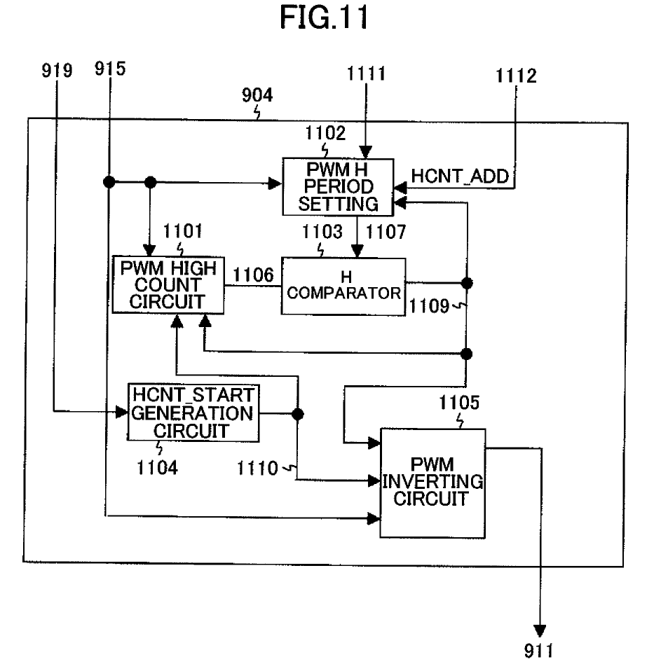

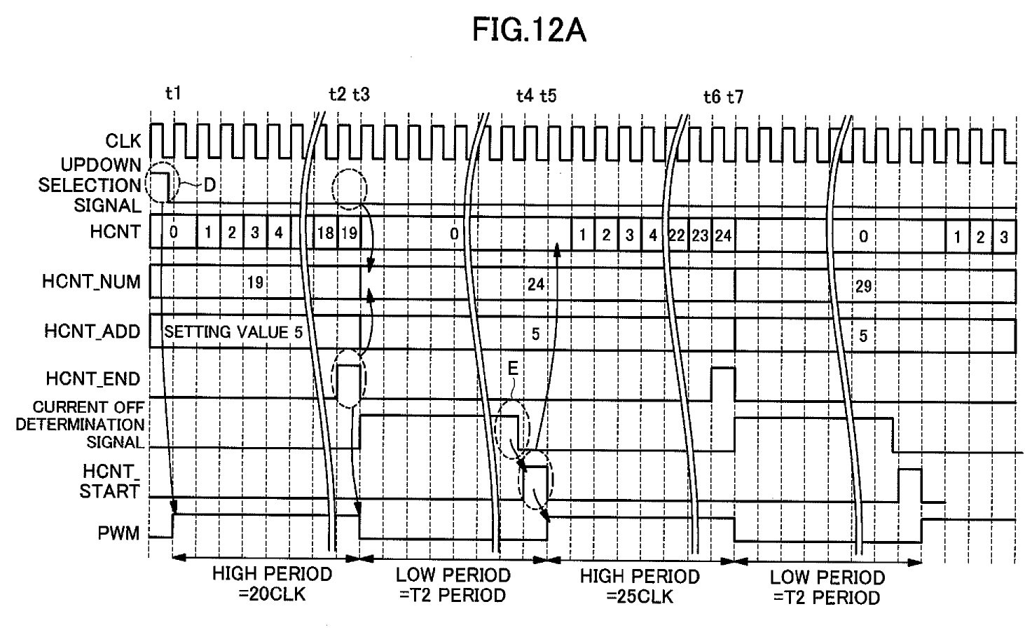

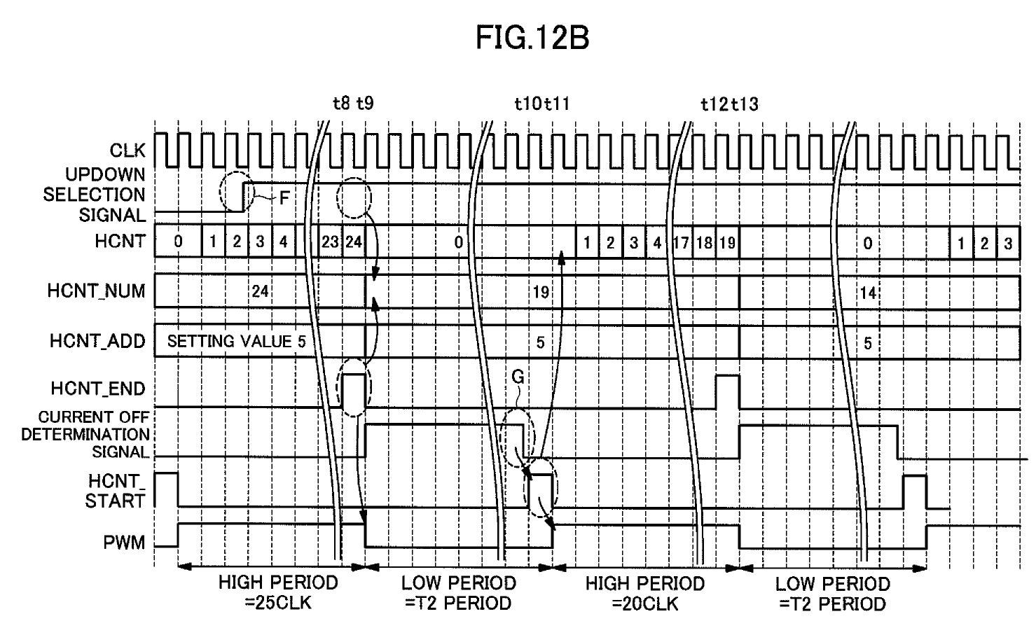

FIG. 11 is block diagram illustrating the PWM generation circuit in the display device according to the third embodiment of the invention and FIGS. 12A and 12B are timing charts illustrating a circuit operation of the PWM generation circuit in the display device according to the third embodiment of the invention. Hereinafter, the configuration and operation of the PWM generation circuit 904 according to the third embodiment will be described based on FIG. 11 and FIGS. 12A and 12B.

The PWM generation circuit 904 includes a PWM HIGH count block 1101, a PWMH period setting block 1102, an H comparator block 1103, a HCNT_START generation block 1104 and a PWM inverting block 1105. Input signals are the UPDOWN selection signal 915, the current OFF determination signal 919, a register value (HCNT_NUM_REG) 1111 for setting a HIGH period initial value of the PWM signal, and a register value (HCNT_ADD_REG) 1112 for setting the increment decrement of the High period of the PWM signal when the PWM cycle is updated. The output signal is the PWM signal 911.

Next, the PWM circuit operation will be described. The UPDOWN selection signal 915 is input to the PWM HIGH count block 1101, the PWMH period setting block 1102 and the PWM inverting block 1105. When the UPDOWM selection signal 915 is in a “High” state, the PWMH period setting block 1102 adds the register setting value (HCNT_REG) 1112 to the register setting value (HCNT_NUM_REG) 1111 which is the counter initial value of the HIGH width of the PWM signal, thereby updating the counter value (HCNT_NUM) 1107 of the HIGH width of the PWM signal . Further, when the UPDOWM selection signal 915 is in a “Low” state, the PWMH period setting block 1102 subtracts the register setting value (HCNT ADD_REG) 1112 from the register setting value (HCNT_NUM_REG) 1111 which is the counter initial value of the HIGH width of the PWM signal, thereby updating the counter value (HCNT_NUM) 1107 of the HIGH width of the PWM signal. In addition, after the current OFF determination signal 919 is input to the HCNT_START generation circuit block 1104, a HCNT_START signal 1110 is generated at the timing at which the current OFF determination signal 919 is transited to the Low state from the High state. The PWM HIGH count block 1101 starts a count operation by employing the HCNT_START signal 1110 as a trigger, and the PWM inverting block 1105 inverts the PWM signal to a High state. Herein, as described in FIG. 10, the current OFF determination signal 919 is in a High state in the T2 period 1010 of FIG. 10 in which the discharge current serving as the supply current I (VCC) flows from the coil, and is in a Low state at the timing at which the discharge current from the coil becomes zero.

First, the case in which the UPDOWN selection signal 915 is in the “Low” state will be described. An output count value (HCNT) 1106 of the PWM HIGH count block 1101 is counted up from zero. The HCNT value is compared with the HIGH period setting value (HCNT_NUM) 1107 of the PWM signal, which is output from the PWMH period setting block 1102, by the H comparator block 1103. When the HCNT is equal to the HCNT_NUM, a HIGH period end signal (HCNT_END) 1109 of the PWM signal, which is output from the H comparator block 1103, is in a High state. The HCNT_END 1109 is input to the PWM HIGH count block 1101, the PWMH period setting block 1102 and the PWM inverting block 1105. The PWM HIGH count block 1101 stops the count operation by employing the HCNT_END 1109 in the High state as a trigger. Herein, the initial value is set to zero. The PWMH period setting block 1102 performs an update to a value, which is obtained by adding the HCNT ADD_REG to the signal HCNT_NUM 1107, by employing the HCNT END 1109 in the High state as a trigger. The PWM inverting block 1105 inverts the PWM signal to a Low state by employing the HCNT END 1109 in the High state as a trigger.

Herein, if the Low period of the PWM signal is started, since the discharge current starts to flow from the coil, the current OFF determination signal 919 is in the High state, and then is in the Low state at the timing at which the discharge current serving as the supply current I (VCC) from the coil becomes zero. The HCNT_START generation circuit 1104 receives the current OFF determination signal 919, and allows the HCNT_START signal 1110 to be in a High state at the timing at which the current OFF determination signal 919 is transited to the low state from the High state. The PWM HIGH count block 1101 starts the count operation again by employing the HCNT_START signal 1110 in the High state as a trigger, and the PWM inverting block 1105 inverts the PWM signal to the High state. The above operation is repeated to generate the PWM signal.

Next, while the High width of the PWM signal is gradually increased when the UPDOWN selection signal 915 is in the “Low” state, since only the difference exists in that the High width of the PWM signal is gradually reduced when the UPDOWN selection signal 915 is in the “High” state, description about the case in which the UPDOWN selection signal 915 is in the “High” state will be omitted.

That is, in the power circuit according to the third embodiment, as indicated by a dotted circle D of FIG. 12A, when the UPDOWN selection signal is changed to the Low state from the High state, the PWM signal 911 output from the PWM inverting block 1105 is inverted to the High state from the Low state at the rising edge of a subsequent clock signal CLK, so that the MOS switch is turned on (time t1). Further, the PWM HIGH count block 1101 counts the clock CLK from the time t1, the HIGH period end signal (HCNT_END) 1109 of the PWM signal is output from the H comparator block 1103 for one clock period at the timing (time t2) at which the count value HCNT 1106 becomes 19 (initial value) which is the HIGH period setting value (HCNT_NUM_REG) 1111 of the PWM signal. At the time t3 at which the HIGH period end signal (HCNT_END) 1109 starts to fall, the PWM signal 911 with the High period of 20 clocks is inverted to a Low state from a High state, so that the MOS switch is turned off. The MOS switch is turned off, so that an electric charge charged in the coil is charged in the capacitor C through the diode. As a result, the potential of the internal node N (917) becomes, high, and the current OFF determination signal 919 is changed to the High state from the Low state at the time t3. Further, at the time t3, after the count value HCNT 1106 of the PWM HIGH count block 1101 is reset to zero, a value 24, which is obtained by adding 5 input as the HCNT_ADD_REG signal 1112 to 19 (the previous count value), is output from the PWMH period setting block 1102 as the HCNT_NUM 1107.

If the electric charge accumulated in the coil is completely discharged, the current OFF determination signal 919 is changed to the Low state from the High state as indicated by a dotted circle E of FIG. 12A. The current OFF determination signal 919 is changed to the Low state, so that the HIGH period start signal (HCNT_START) 1110 of the PWM signal is output from the HCNT_START generation block 1104 for one clock period at the time t4. At the timing (time t5) at which the HIGH period start signal (HCNT_START) 1110 of the PWM signal starts to fall, the PWM signal 911 is inverted to a High state from a Low state, so that the MOS switch is turned on. Further, at the time t5, the PWM HIGH count block 1101 starts to count the clock CLK.

After the time t6, the above-described operation from the time t2 to the time t7 is repeated, so that the supply voltage VCC is stepped up, resulting in the obtaining of the step-up voltage VO.

Meanwhile, as indicated by a dotted circle F of FIG. 12B, when the UPDOWN selection signal is changed to the High state from the Low state, the operation performed during the change thereof, that is, the operation when the UPDOWN selection signal is in the Low state is continued. In other words, the operation when the HCNT_NUM is equal to 24 is continued. Thus, at the timing (time t8) at which the count value HCNT 1106 of the PWM HIGH count block 1101 becomes 24 which is the HIGH period setting value (HCNT_NUM) 1107 of the PWM signal, the HIGH period end signal (HCNT_END) 1109 is output for one clock period. Then, at the time t9 at which the HIGH period end signal (HCNT_END) 1109 starts to fall, the PWM signal 911 is inverted to the Low state from the High state, so that the MOS switch is turned off. The MOS switch is turned off, so that the electric charge charged in the coil is charged in the capacitor C through the diode. As a result, the potential of the internal node N (917) becomes high, and the current OFF determination signal 919 is changed to the High state from the Low state at the time t9. Further, at the time t9, after the count value HCNT 1106 of the PWM HIGH count block 1101 is reset to zero, a value 19, which is obtained by subtracting 5 input as the HCNT_ADD_REG signal 1112 from 24 (the previous count value), is output from the PWMH period setting block 1102 as the HCNT_NUM 1107.

If the electric charge accumulated in the coil is completely discharged, the current OFF determination signal 919 is changed to the Low state from the High state as indicated by a dotted circle G of FIG. 12B. The current OFF determination signal 919 is changed to the Low state, so that the HIGH period start signal (HCNT_START) 1110 of the PWM signal is output from the HCNT_START generation block 1104 for one clock period at the time t10. At the timing (time t11) at which the HIGH period start signal (HCNT_START) 1110 of the PWM signal starts to fall, the PWM signal 911 is inverted to the High state from the Low state, so that the MOS switch is turned on. Further, at the time t11, the PWM HIGH count block 1101 starts to count the clock CLK.

After the time t11, the above-described operation from the time t8 to the time t13 is repeated, resulting in the obtaining of the step-up voltage VO.

In the above description, a horizontal period synchronizing signal and a vertical period synchronizing signal, which are input to the PWM generation circuit 904 shown in FIG. 9, are not described. However, the PWM generation circuit 904 can operate in synchronization with the horizontal period synchronizing signal and the vertical period synchronizing signal similar to the embodiment 1. For example, after the horizontal period synchronizing signal and the vertical period synchronizing signal are input to the PWM generation circuit 904, when line switching and frame switching are performed, the entire circuit may operate after being initialized. Further, at the timing at which the line switching and the frame switching are performed, since charge/discharge current of the panel is expected to be large, even when the UPDOWN selection signal 915 is in the Low state, the UPDOWN selection signal 915 may be transited in the period in which the High width of the PWM signal is increased.

As described above, the power circuit according to the third embodiment of the invention includes the coil 905 that charges an electric charge of an input voltage, the MOS switch 906 that controls charging and discharging of the coil 905, the diode 907 that rectifies the flow of the electric charge from the coil 905, the capacitor 908 that stabilizes an output voltage when the MOS switch 906 is turned on, the MOS switch 916 and the PWM generation circuit 904. The MOS switch 916 has the gate connected to the internal node 917 of the switching regulator step-up circuit 903, the drain connected to the step-up voltage (VO) and the source connected to the resistor for resistance-dividing the step-up voltage. The PWM generation circuit 904 generates the PWM signal 911, which is used for generating a clock signal serving as a reference of the charge/discharge operation of the coil 905 and the capacitor 908, according to the UPDOWN selection signal 915, which is obtained by comparing the voltage 913 obtained by dividing the step-up voltage (VO) 912 with the reference voltage (Vref)) 914 by the comparator circuit 909a, and the current OFF determination signal 919 which is obtained by comparing the voltage 918 obtained by dividing the step-up voltage (VO) 912 controlled by the MOS switch 916 with the reference voltage (Vref) 914 by the comparator circuit 909b. The PWM operation is performed in a period in which the High period is increased and in a period in which the High period is reduced. The PWM generation circuit of the PWM signal does not fix the PWM cycle during the PWM operation, monitors the internal node 917 of the switching regulator step-up circuit 903, and detects the timing at which the discharge current from the coil becomes zero, thereby determining the Low period of the PWM signal. Consequently, a decrement of the step-up voltage due to a panel load and resistance components of the diode can be suppressed, resulting in the improvement of power efficiency.

That is, the power circuit of the display device according to the third embodiment includes the internal node N (917), which serves as a signal line for detection and is connected to one end of the coil 905 having the other end connected to the supply voltage, and a detection circuit provided with the MOS switch 916, which is connected to the internal node N (917), and the comparator circuit 909b which compares the voltage 918, which is obtained by dividing the step-up voltage (VO) 912 controlled by the MOS switch 916, with the reference voltage (Vref) 914. The PWM generation circuit 904 serving as the driving circuit determines and controls the off-period of the MOS switch 906, that is, the Low period of the PWM signal, based on the period in which the discharge current 1005 from the coil 905 detected by the detection circuit becomes zero. Consequently, the output voltage can be stepped up by using a short High period of the PWM signal, and a decrement of the step-up voltage due to a panel load and resistance components of the diode can be suppressed, resulting in the improvement of power efficiency.

As described above, the power circuit of the liquid crystal display device according to the third embodiment determines the Toff period by directly detecting the time at which the discharge current of the coil ends from the internal node of the switching regulator step-up circuit.

In addition, in the first to third embodiments, the power circuit of the display device according to the invention is applied to a power circuit of a liquid crystal display device. However, the power circuit of the invention can also be applied to other flat type display devices, such as a display device using an organic light emitting diode (OLED) or an organic EL display device, and a power circuit of other electronic apparatuses, as well as the power circuit of the liquid crystal display device

While there have been described what are at present considered to be certain embodiments of the invention, it will be understood that various modifications may be made thereto, and it is intended that the appended claims cover all such modifications as fall within the true spirit and scope of the invention.

What is claimed is:

1. A power circuit comprising:
a coil that charges an electric charge of an input voltage;
a switch device that controls charging and discharging of the coil;
a diode that rectifies flow of the electric charge from the coil;
a capacitor that stabilizes an output voltage when the switch device is turned on; and
a driving circuit that controls ON and OFF states of the switch device,
wherein the power circuit alternately switches the ON and OFF states of the switch device to control charging and discharging of the coil and the capacitor, and generates and supplies an output voltage higher than the input voltage, and
the driving circuit controls an off -period of the switch device according to an on-period of the switch device, and a voltage ratio of the output voltage and the input voltage while changing a repetition period of the ON and OFF states of the switch device.

2. The power circuit according to claim 1, further comprising a comparison circuit that compares the voltage ratio of the output voltage and the input voltage,
wherein the driving circuit switches a first period, in which the output voltage is controlled by controlling switching of the ON and OFF states of the switch device, and a second period, in which the output voltage is controlled by stopping the switching of the ON and OFF states of the switch device, according to a comparison result of the comparison circuit.

3. The power circuit according to claim 2, wherein the driving circuit includes a clock generation circuit that generates a clock signal for alternately switching the ON and OFF states of the switch device, and changes a cycle of the clock signal according to the comparison result of the comparison circuit.

4. The power circuit according to claim 1, further comprising a nonvolatile storage unit that stores information on the on-period and the off-period of the switch device.

5. A power circuit comprising:
a coil that charges an electric charge of an input voltage;
a switch device that controls charging and discharging of the coil;
a diode that rectifies flow of the electric charge from the coil;
a capacitor that stabilizes an output voltage when the switch device is turned on; and
a driving circuit that controls ON and OFF states of the switch device,
wherein the power circuit alternately switches the ON and OFF states of the switch device to control charging and discharging of the coil and the capacitor, and generates and supplies an output voltage higher than the input voltage, and
the driving circuit controls an off-period of the switch device according to an on-period of the switch device and a voltage ratio of the output voltage and the input voltage while controlling the on-period and the off-period of the switch device such that a repetition period of the ON and OFF states of the switch device coincides with any one of at least two repetition periods different from each other.

6. The power circuit according to claim 5, further comprising a comparison circuit that compares the voltage ratio of the output voltage and the input voltage,
wherein the driving circuit switches a first period, in which the output voltage is controlled by controlling switching of the ON and OFF states of the switch device, and a second period, in which the output voltage is controlled by stopping the switching of the ON and OFF states of the switch device, according to a comparison result of the comparison circuit.

7. The power circuit according to claim 6, wherein the driving circuit includes a clock generation circuit that generates first and second clock signals, which have cycles of the two repetition periods and alternately switch the ON and OFF states of the switch device, and selects one of the first and second clock signals according to the comparison result of the comparison circuit.

8. The power circuit according to claim 5, further comprising a nonvolatile storage unit that stores information on the on-period and the off-period of the switch device.

9. A power circuit comprising:
a coil that charges an electric charge of an input voltage;
a switch device that controls charging and discharging of the coil;
a diode that rectifies flow of the electric charge from the coil;
a capacitor that stabilizes an output voltage when the switch device is turned on;
a driving circuit that controls ON and OFF states of the switch device; and
a detection circuit that detects a discharge current from the coil,
wherein the power circuit alternately switches the ON and OFF states of the switch device to control charging and discharging of the coil and the capacitor, and generates and supplies an output voltage higher than the input voltage, and
the driving circuit controls an off-period of the switch device based on a period in which the discharge current detected by the detection circuit becomes zero.

10. The power circuit according to claim 9, further comprising a comparison circuit that compares the voltage ratio of the output voltage and the input voltage,
wherein the driving circuit switches a first period, in which the output voltage is controlled by controlling switching of the ON and OFF states of the switch device, and a second period, in which the output voltage is controlled by stopping the switching of the ON and OFF states of the switch device, according to a comparison result of the comparison circuit.

11. The power circuit according to claim 10, wherein the detection circuit includes a circuit which is connected to one end of the coil having the other end to which the input voltage is applied, and directly detects the discharge current of the coil.

12. The power circuit according to claim 10, further comprising a comparison circuit that compares the voltage ratio of the output voltage and the input voltage,
wherein the driving circuit switches a first period, in which the output voltage is controlled by controlling switching of the ON and OFF states of the switch device, and a second period, in which the output voltage is controlled by stopping the switching of the ON and OFF states of the switch device, according to a comparison result of the comparison circuit and a detection result of the detection circuit.

13. The power circuit according to claim 10, wherein the driving circuit includes a clock generation circuit that generates a clock signal for alternately switching the ON and OFF states of the switch device, and changes a cycle of the clock signal according to the comparison result of the comparison circuit and a detection result of the detection circuit.

14. The power circuit according to claim 10, further comprising a nonvolatile storage unit that stores the on-period of the switch device.

15. A display device comprising:
a display driving circuit including the power circuit according to claim 1; and
a display panel that displays an image according to display data from the display driving circuit.

16. A display device comprising:
a display driving circuit including the power circuit according to claim 5; and
a display panel that displays an image according to display data from the display driving circuit.

17. A display device comprising:
a display driving circuit including the power circuit according to claim 9; and
a display panel that displays an image according to display data from the display driving circuit.
